(19) United States
(12) Patent Application Publication
(10) Pub. No.: US 2024/0140352 A1
(43) Pub. Date: May 2, 2024

(54) VEHICLE SEATBELT DEVICE

(71) Applicant: AUTOLIV ASP, INC., Ogden, UT (US)

(72) Inventors: David SCHNEIDER, Ogden, UT (US); Changsoo CHOI, Ogden, UT (US); Christina MORRIS, Ogden, UT (US)

(73) Assignee: AUTOLIV ASP, INC., Ogden, UT (US)

(21) Appl. No.: 18/050,840

(22) Filed: Oct. 28, 2022

(51) Int. Cl. B60R 22/20; B60R 21/0134; B60R 22/26; B60R 22/48

(52) U.S. Cl. CPC B60R 22/20; B60R 21/0134; B60R 22/26; B60R 22/48; B60R 2022/208

(57) ABSTRACT

A seatbelt of a vehicle includes a buckle tilt mounting device for a tongue plate coupled with a seatbelt webbing restraining an occupant seated in a vehicle seat. The buckle tilt mounting device includes a buckle assembly having a buckle and a buckle cable, and further includes a pre-tensioner system having a housing, a driving member, and a pre-tensioner cable. When the pre-tensioner system is actuated at a time of a vehicle collision or at a time a vehicle collision is anticipated, the driving member retracts the pre-tensioner cable inside the housing such that the buckle assembly is rotatably moved and configured to reduce submarining load on the occupant.

### FIELD

The present disclosure relates to a seatbelt device for a vehicle and more particularly to the seatbelt device with a pre-tensioner system for the vehicle.

### BACKGROUND

The statements in this section merely provide background information related to the present disclosure and may not constitute prior art.

In general, a vehicle has a seatbelt device for restraining an occupant seated in a vehicle seat. A webbing of the seatbelt device formed with a three-point seatbelt has a shoulder belt portion and a lap belt portion. Further, in a typical single pre-tensioner system, an intermediate portion of the webbing between the shoulder belt portion and the lap belt portion is inserted-through a slot formed in a tongue plate. Due to the tongue plate connected to a buckle that is disposed at a side of the vehicle seat, the shoulder belt portion restrains the upper body (e.g., chest) of the occupant and the lap belt portion restrains the waist or abdomen region of the occupant. For example, one of the seatbelt devices has a shoulder pre-tensioner that, at a time of a vehicle collision, forcibly pulls the shoulder belt portion toward the opposite side from the tongue plate (i.e. the rearward of the vehicle), and due to the lap belt portion moving toward the shoulder belt portion through the slot of the tongue plate, the tension of the lap belt portion increases to help the belt portions better engage with the occupant. In some current belt system designs, there is a risk that a submarine phenomenon may occur.

The submarine phenomenon generally refers to a phenomenon that a dummy is moved down relatively from the seatbelt during the collision of the vehicle and has several problems. One of them is that a webbing of the seatbelt moves relatively upward by the downward movement of the dummy and thus is caught in the soft abdominal tissues of the occupant. Further, the webbing of the seatbelt caught in the abdomen occurs when, at a time of the vehicle collision, the webbing of the seatbelt moves upward from the pelvis of the dummy to the abdomen excessively and presses the abdomen of the occupant without muscles and bones, resulting in excessively pressing the abdomen of the occupant. It is well known that seating of the webbing on the abdomen brings the pelvis of the occupant to move farther so that the occupant may be injured more seriously and unstable mobility of the upper part of the occupant may bring an unexpected mobility of the occupant, and that the abdominal pressure may bring the rupture of the internal organs and the like in the vehicle collision accident.

### SUMMARY

In view of the above-described circumstances, an object of the present disclosure is to provide a seatbelt device having a buckle tilt mounting device to make a buckle assembly rotatably move forward at a time of a vehicle collision or at a time a vehicle collision is anticipated. During the time of the vehicle collision or the time the vehicle collision is anticipated, the seat belt device of the present disclosure repositions the seatbelt buckle to a position which enhances the restraint performance for the occupants. The present disclosure relates to a seatbelt device for securing an occupant seated in a vehicle seat. The seatbelt device includes a tongue plate coupled with a seatbelt webbing for restraining the occupant, a buckle releasably receiving the tongue plate, a buckle cable having a first buckle cable end rotatably attached to a buckle mounting bracket of the vehicle seat or the vehicle structure and a second buckle cable end fixedly connected to the buckle, a load transmission system including a housing and a driving member disposed inside the housing, and a pre-tensioner cable having a first end fixedly connected to the driving member and a second end fixedly connected with the buckle cable. Further, the buckle coupled with the tongue plate is rotatably moved to an actuated position from an unactuated position when the load transmission system is actuated at a time of a vehicle collision or at a time a vehicle collision is anticipated.

According to a further aspect of the present disclosure, the seatbelt device further includes a coupling member providing a connection between the second end of the pre-tensioner cable and the second buckle cable end of the buckle cable such that the pre-tensioner cable and the buckle cable are fixedly connected to each other.

According to a further aspect of the present disclosure, in the actuated position of the buckle, the buckle fixedly attached to the buckle cable rotates forward about an anchor defined as a location where the first buckle cable end is rotatably attached to the buckle mounting bracket. Due to the rotational movement of the buckle fixedly attached to the buckle cable, the buckle in the actuated position is located forward and downward from the buckle located in the unactuated position.

According to a further aspect of the present disclosure, the load transmission system is attached to the buckle mounting bracket and further includes a gas generator configured to move the driving member inside the housing along a longitudinal axis of the housing at the time of the vehicle collision or at the time the vehicle condition is anticipated. When the load transmission system is actuated, the driving member connected with the pre-tensioner cable moves forward along the longitudinal axis of the housing such that the driving member retracts the pre-tensioner cable inside the housing.

According to a further aspect of the present disclosure, due to the movement of the buckle engaged with a lap belt portion of the webbing via the tongue plate, the seatbelt device is configured to reduce submarining load on the occupant at the time of the vehicle collision or at the time the vehicle collision is anticipated.

According to a further aspect of the present disclosure, when the load transmission system is actuated, the driving member connected with the pre-tensioner cable moves rearward along the longitudinal axis of the housing such that the driving member retracts the pre-tensioner cable inside the housing.

According to another aspect of the present disclosure, a buckle tilt mounting device for a seatbelt webbing with a tongue plate restraining an occupant seated in a vehicle seat includes a buckle assembly having a buckle and a buckle cable, and a pre-tensioner system having a housing, a driving member, and a pre-tensioner cable. The buckle releasably receives the tongue plate and the buckle cable has a first buckle cable end rotatably attached to a buckle mounting bracket of the vehicle seat or the vehicle structure and a second buckle cable end fixedly connected to the buckle. The driving member of the pre-tensioner system is movable along a longitudinal axis of the housing and the pre-tensioner cable has a first end fixedly connected to the driving member and a second end fixedly connected to the buckle cable. Further, the driving member retracts the pre-tensioner cable inside the housing when the pre-tensioner system is actuated and at a time of a vehicle collision or at a time a vehicle collision is anticipated such that the buckle assembly is rotatably moved and configured to reduce submarining load on the occupant.

Further details and benefits will become apparent from the following detailed description of the appended drawings. The drawings are provided herewith purely for illustrative purposes and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 is a side view showing a state in which an occupant seated in a vehicle seat is wearing a seatbelt device in accordance with an exemplary embodiment of the present disclosure;

FIG. 2 is a side view showing relevant portions of the seatbelt device in an unactuated position of the seatbelt device of FIG. 1;

FIG. 3 is a side view showing the relevant portions of the seatbelt device in an actuated position of the seatbelt device of FIG. 1;

FIG. 4 is a side view showing a pre-tensioner system of the seatbelt device of FIG. 1;

FIG. 5 is a side view showing relevant portions of the seatbelt device in an unactuated position of a seatbelt device in accordance with the second embodiment of the present disclosure;

FIG. 6 is a side view showing the relevant portions of the seatbelt device in an actuated position of the seatbelt device of FIG. 5; and

FIG. 7 a side view showing relevant portions of the seatbelt device in an unactuated position in accordance with another embodiment of the present disclosure.

The drawings described herein are for illustration purposes only and are not intended to limit the scope of the present disclosure in any way.

### DETAILED DESCRIPTION

The following description is merely exemplary in nature and is in no way intended to limit the present disclosure or its application or uses. It should be understood that throughout the drawings, corresponding reference numerals indicate like or corresponding parts and features.

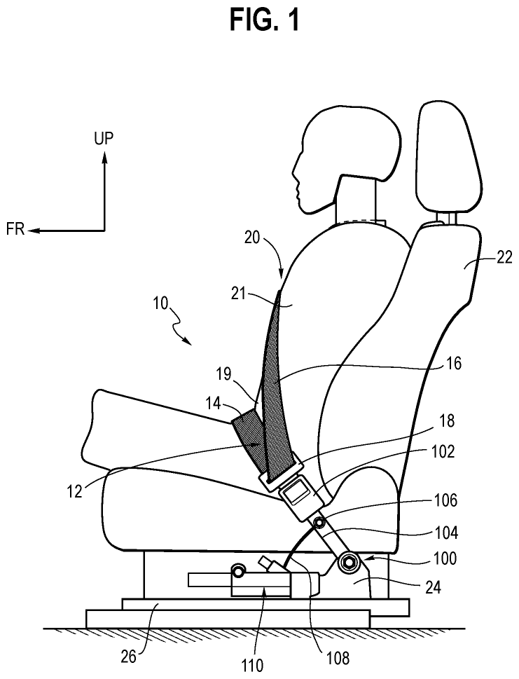

FIG. 1 shows a perspective view of an occupant being seated in a vehicle seat and wearing a vehicle seatbelt device. As illustrated in FIG. 1, the seatbelt device 10 of the vehicle includes a webbing 12 having a lap belt portion 14 and a shoulder belt portion 16, and a tongue plate 18 slidably or fixedly coupled to the webbing 12. As shown in FIG. 1, the lap belt portion 14 is part of the webbing 12 for restraining the waist or abdomen 19 of the occupant 20 seated in the vehicle seat 22, and the shoulder belt portion 16 is also part of the webbing 12 for restraining the chest 21 of the occupant 20. The webbing 12 is a flexible belt-shaped member.

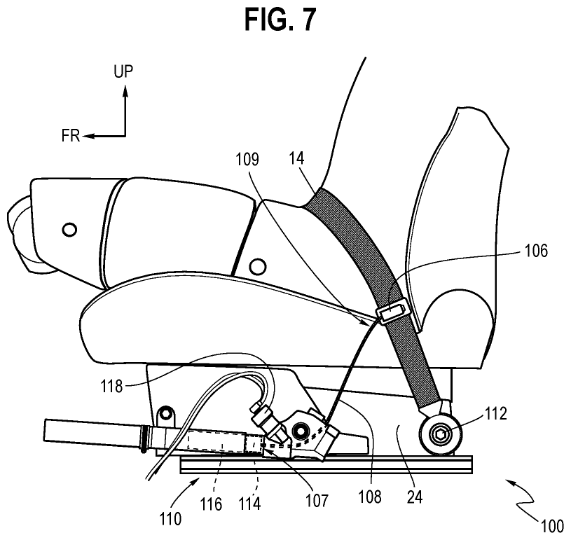

As shown in FIG. 1, the seatbelt device 10 further includes a buckle tilt mounting device 100 having a buckle 102, a buckle cable or strap 104, and a coupling member 106. In addition, the buckle tilt mounting device 100 includes a load transmission system such as a pre-tensioner system 110 with a pre-tensioner cable 108, which is connected to the buckle cable or strap 104 via the coupling member 106. In another approach, the pre-tensioner cable 108 is provided in the form of a strap. As shown in FIG. 1, the tongue plate 18 is releasably engaged to the buckle 102 when the occupant 20 puts on the webbing 12 (i.e., the seatbelt is worn). As an example of FIG. 1, the buckle 102 is provided at the inner side of the vehicle seat 22 in the vehicle width direction, and the webbing 12 is divided into the lap belt portion 14 and the shoulder belt portion 16 at the position of the tongue plate 18 when the seatbelt is put on. Further, the buckle cable (or strap) may be formed with a metal strap or a fabric/webbing material. In accordance with other embodiments of the present disclosure, the buckle 102 may be provided at the outer side or both sides (the inner and outer sides) of the vehicle seat 22 in the vehicle width direction, and additionally, the pre-tensioner cable 108 may be attached directly to the lap belt portion 14 of the seatbelt webbing 12 through a coupling member 106, for instance, on the anchor side 112 of the seatbelt assembly, where there is no buckle (see FIG. 7). As shown in FIG. 7, the pre-tensioner cable 108 of the pre-tensioner system 110 is attached to a location of the webbing 12 spaced from the anchor 112 defined as an actuated position of the pre-tensioner system 110.

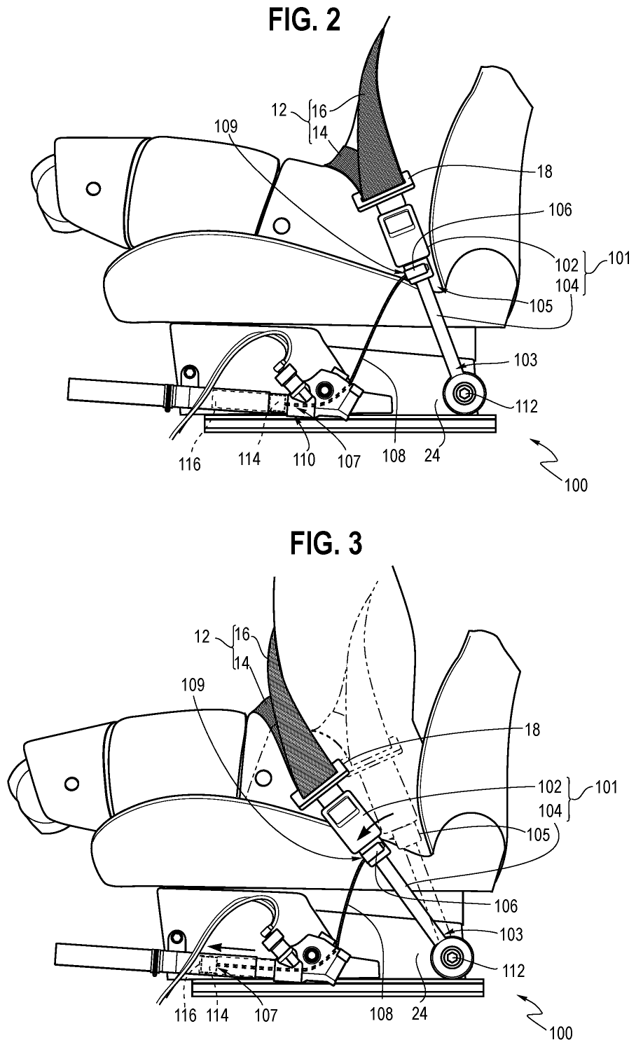

FIG. 2 shows a buckle tilt mounting device 100 having a buckle assembly 101 that is fixedly engaged with the pre-tensioner system 110 via the coupled pre-tensioner cable 108 with the buckle cable 104 as an example of the present disclosure. In FIG. 2, the buckle cable 104 has a first buckle cable end 103 rotatably attached to an anchor 112 defined in a buckle mounting bracket 24 mounted to the vehicle seat rail assembly 26 of the vehicle (not shown) and a second buckle cable end 105 extending from the first buckle cable end 103 to be fixedly connected to the buckle 102. Further, the pre-tensioner cable 108 of the pre-tensioner system 110 has a first end 107 fixedly attached to a driving member such as a piston 114 inside a housing 116 formed with a cylindrical shape in the pre-tensioner system 110 and a second end 109 extending from the first end 107 to be fixedly connected to the buckle cable 104 via the coupling member 106. As shown in FIG. 2, the buckle cable or strap 104 is a flexible member that is fixedly connected to the buckle 102 and the anchor 112 of the buckle mounting bracket 24.

Normally, as shown in FIG. 2, when the pre-tensioner system 110 has not been actuated, the buckle 102 coupled with the tongue plate 18 of the seatbelt device 10 is positioned at the upward and forward location relative to the anchor 112 of the buckle mounting bracket 24, which is defined as an unactuated position of the buckle 102. In the unactuated position of the buckle 102, the pre-tensioner cable 108 fixedly connected to the buckle cable 104 fully extends beyond the housing 116 of the pre-tensioner system 110 with a length.

FIG. 3 shows the position of the buckle 102 releasably coupled with the tongue plate 18 of the seatbelt device 10 when the pre-tensioner system 110 is actuated. As shown in FIG. 3, when the pre-tensioner system 110 is actuated, the buckle 102 with the buckle cable 104 is rotated forward relative to the anchor 112 of the buckle mounting bracket 24 defined as an actuated position of the buckle 102 such that the position of the buckle 102 is changed to move forward and downward relative to the buckle's location in the unactuated position of the buckle 102. Accordingly, in the actuated position of the buckle 102, the length of the pre-tensioner cable 108 beyond the housing 116 is decreased because as shown in FIG. 3, the piston 114 moves away from the anchor location 112 (i.e., move forward inside the cylinder housing 116) such that the pre-tensioner cable 108 connected to the piston 114 is retracted inside the housing and also moves forward together with the piston 114. In another embodiment of FIG. 7, when actuated (not shown), the pre-tensioner cable 108 directly attached to the webbing 12 via the coupling member 106 is retracted inside the housing and moves forward together with the piston 114 such that the webbing 12 (i.e. lap belt portion 14) of the seatbelt connected to the pre-tensioner cable 108 via the coupling member 106 is rotatably moved forward.

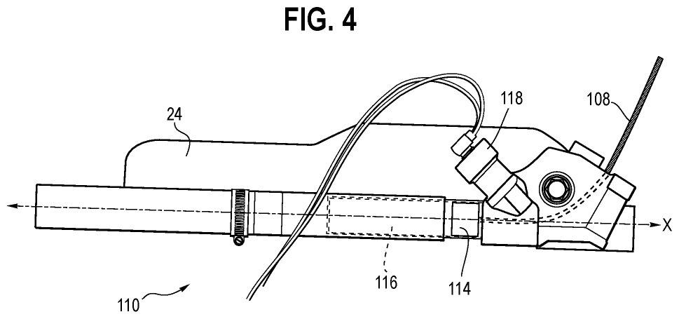

FIG. 4 shows the pre-tensioner system 110 attached to the buckle mounting bracket 24, which is provided at the front of the anchor 112. In another approach, the pre-tensioner system 110 may be positioned in other locations of the vehicle seat such as a rearward side of the anchor 112 (not shown). In FIG. 4, the pre-tensioner system 110 is a gas generation type pretensioner that is actuated at a time of a vehicle collision or at a time a vehicle collision is anticipated. The pre-tensioner system 110 includes the piston 114 (i.e., the driving member) that is provided within the cylinder housing 116, and a gas generator 118. Gas is generated by the gas generator 118 when the pre-tensioner system 110 is actuated, and the gas pressure moves the piston 114 within the cylinder housing 116 toward the vehicle front, which is away from the anchor 112.

As shown in FIGS. 2 and 3, the first end 107 of the pre-tensioner cable 108 is fixedly connected to the piston 114 of the pre-tensioner system 110 and the second end 109 of the pre-tensioner cable 108 is coupled to the second buckle cable end 105 of the buckle cable 104 via the coupling member 106, which is fixedly connected to each of the buckle cable 104 and the pre-tensioner cable 108. Further, the first end 107 of the pre-tensioner cable 108 is connected to the piston 114 inside the cylinder housing 116 so as to be capable of movement such that when the pre-tensioner system 110 is actuated (i.e., the gas is generated by the gas generator), the pre-tensioner cable 108 formed with a flexible member is retracted into the inside of the cylinder housing 116. The first end 107 of the pre-tensioner cable 108 is fixedly connected to the piston 114 of the pre-tensioner system 110 and the second end 109 of the pre-tensioner cable 108 is fixedly connected to the second buckle cable end 105 of the buckle cable 104. The pre-tensioner cable 108 is retracted by the pre-tensioner system 110 due to movement of the piston 114 toward the vehicle front side when the pre-tensioner system 110 is actuated (see FIG. 3) such that the buckle 102 with the buckle cable 104 connected with the pre-tensioner cable 108 via the coupling member 106 is rotatably moved toward the vehicle front side. Accordingly, as shown in FIG. 3, when the pre-tensioner system 110 has been actuated, the buckle 102 is rotated toward the forward and downward directions from the unactuated position of the buckle 102 such that in the actuated position of the buckle 102, the buckle 102 is located at the forward and downward side relative to the buckle located in the unactuated position.

As shown in FIGS. 2 and 3, the pre-tensioner system 110 and the buckle assembly 101 are each attached to the buckle mounting bracket 24, which is fixed to the vehicle seat rail assembly 26 of the vehicle seat 22. Alternatively, the buckle mounting bracket 24 may be attached to the vehicle structure (not shown). Using the buckle mounting bracket 24 enhances the ease of assembly of the buckle assembly 101 and the pre-tensioner system 110 to the vehicle seat 22. Further, in order to increase the retraction efficiency of the pre-tensioner system 110 within the limited space of the vehicle seat 22, an angle formed between the pre-tensioner cable 108 and the buckle cable 104 is substantially between 20 and 160 degrees at the location of the coupling member 106 (i.e. forming a triangle shape) so that tension in the pre-tensioner cable 108 pulls the buckle forward and downward. However, in accordance with other forms of the present disclosure, the angle may be formed with any angles formed between the pre-tensioner cable 108 and the buckle cable 104.

In the vehicle seatbelt device 10 of FIGS. 2 and 3, the pre-tensioner cable 108 is retracted by the pre-tensioner system 110 provided in the front side of the anchor 112 when the pre-tensioner system 110 is actuated in a vehicle collision or in an anticipated vehicle collision. When this occurs, the pre-tensioner cable 108 is smoothly retracted in a predetermined direction. As described above, the buckle cable 104 extends from the anchor 112 and is fixedly connected to the buckle 102 at the second buckle cable end 105 of the buckle cable 104, and the pre-tensioner cable 108 is also connected to the second buckle cable end 105 of the buckle cable 104 such that the pre-tensioner cable 108 is fixedly coupled with the buckle cable 104. Thus, as the pre-tensioner cable 108 is retracted by the pre-tensioner system 110, the second buckle cable end 105 of the buckle cable 104 connected to the second end 109 of the pre-tensioner cable 108 is pulled toward the vehicle front side and the buckle 102 connected to the second buckle cable end 105 rotatably moves toward the vehicle front side and the vehicle lower side, which is defined as the actuated position (see FIG. 3).

As shown in an example of FIGS. 2 and 3, in a state in which the seatbelt is being worn, the tongue plate 18 coupled to the webbing 12 having the lap belt portion 14 and the shoulder belt portion 16 is securely inserted into the buckle 102, and thus the lap belt portion 14 of the webbing 12 also moves according to the movement of the buckle 102. When an electronic control unit (ECU) in the vehicle (not shown) judges, on the basis of the output from a collision predicting sensor, that a front collision of the vehicle is inevitable, the ECU activates the gas generator 118 of the pre-tensioner system 110. Due to the actuation of the pre-tensioner system 110, the buckle 102 connected to the buckle cable 104 is rotated and driven toward the vehicle front side such that the location of the buckle 102 is moved to the actuated position (see FIG. 3) from the unactuated position (see FIG. 2). As a result, the lap belt portion 14 connected to the buckle 102 via the tongue plate 18 is pulled downward (see an arrow in FIG. 3). Accordingly, it prevents the lap belt portion 14 from coming away from the waist or abdomen 19 of the occupant 20 such that the occurrence of the submarine phenomenon is suppressed. Further, in the present disclosure, the pre-tensioner system 110 with the pre-tensioner cable 108 has the gas generator 118 that rotates and drives the buckle 102 with the buckle cable 104 toward the vehicle front side relative to the anchor 112. By using this pre-tensioner system 110 having the gas generator 118, the structure of the buckle tilt mounting device 100 can be simplified and the buckle assembly 101 having the buckle 102 and the buckle cable 104 can be tilted forward quickly at a predetermined time.

As described above, the lap belt portion 14 coupled to the buckle 102 is pulled toward the downward side of the vehicle when the pre-tensioner system 110 is actuated because the pre-tensioner cable 108 connected to the piston 114 is retracted inside the cylinder housing 116 of the pre-tensioner system 110 such that the location of the buckle 102 coupled with the lap belt portion 14 is moved to the actuated position from the unactuated position. As a result, as shown in FIG. 3, this enables improved restraining force on the waist or abdomen 19 of the occupant 20 during the vehicle collision. Accordingly, the buckle 102 coupled with the lap belt portion 14 moves toward the downward side and the forward side of the vehicle in a vehicle collision or in an anticipated vehicle collision such that the waist or abdomen 19 of the occupant 20 is enabled to be efficiently restrained by the lap belt portion 14 of the webbing 12.

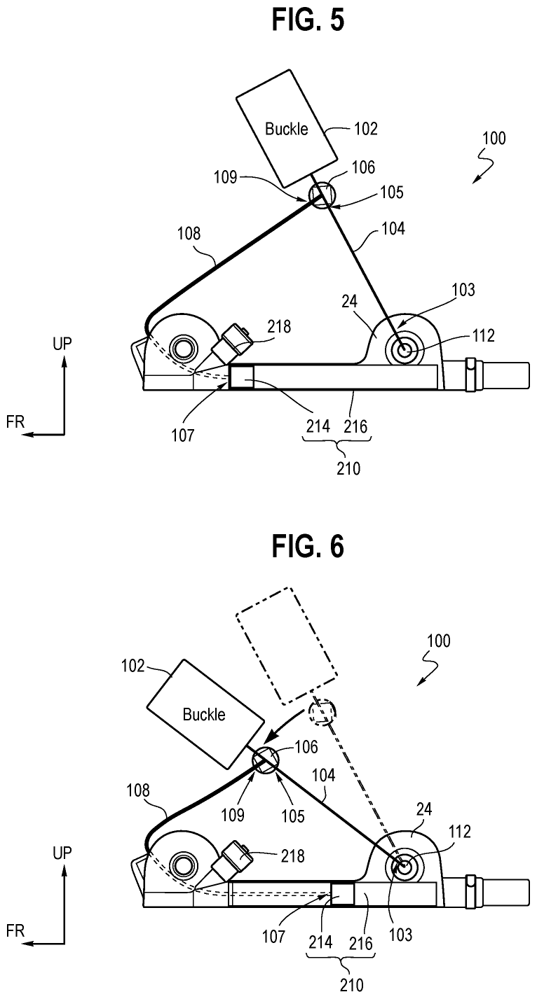

FIGS. 5 and 6 show a second embodiment of the present disclosure having a pre-tensioner system 210, which is only different from the pre-tensioner system 110 described and shown in the first embodiment of FIGS. 2 and 3. FIG. 5 shows the buckle assembly 101 connected to the pre-tensioner system 210 in the unactuated position of the buckle 102 and FIG. 6 shows the buckle assembly 101 connected to the pre-tensioner system 210 in the actuated position of the buckle 102. The pre-tensioner system 210 attached to the buckle mounting bracket 24 has a piston 214, a housing 216, and a gas generator 218. In the pre-tensioner system 210, when the pre-tensioner system 210 is actuated, the piston 214 moves toward a vehicle rearward direction, which is the opposite direction from the driving member 114 of the pre-tensioner system 110 shown in FIGS. 2 and 3, which moves toward the vehicle forward direction. As shown in FIGS. 5 and 6, further, the first end 107 of the pre-tensioner cable 108 is connected to the piston 214 through the front side of the housing 216, but in the FIGS. 2 and 3, the first end 107 of the pre-tensioner cable 108 is connected to the position 114 through the back side of the housing 116. Accordingly, as shown in FIGS. 5 and 6, when the pre-tensioner system 210 is actuated at a time of a vehicle collision or at a time a vehicle collision is anticipated, the pre-tensioner cable 108 is retracted inside the housing 216 of the pre-tensioner system 210 through the front side of the housing 216 and the buckle assembly 101 is rotated forward such that the waist or abdomen 19 of the occupant 20 is enabled to be efficiently restrained by the lap belt portion 14 of the webbing 12.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A seatbelt device for securing an occupant seated in a vehicle seat, the seatbelt device comprising:
a tongue plate coupled with a seatbelt webbing for restraining the occupant;
a buckle releasably receiving the tongue plate;
a buckle cable having a first buckle cable end rotatably attached to a buckle mounting bracket of the vehicle seat and a second buckle cable end fixedly connected to the buckle;
a load transmission system including a housing and a driving member disposed inside the housing; and
a pre-tensioner cable having a first end fixedly connected to the driving member and a second end fixedly connected with the second buckle cable end of the buckle cable at a location next to the buckle,
wherein the buckle coupled with the tongue plate is rotatably moved to an actuated position from an unactuated position when the load transmission system is actuated at a time of a vehicle collision or at a time the vehicle collision is anticipated.

2. The seatbelt device of claim 1, further comprising a coupling member providing a connection between the second end of the pre-tensioner cable and the second buckle cable end of the buckle cable such that the pre-tensioner cable and the buckle cable are fixedly connected to each other.

3. The seatbelt device of claim 1, wherein, in the actuated position of the buckle, the buckle fixedly attached to the buckle cable rotates forward about an anchor defined as a location where the first buckle cable end is rotatably attached to the buckle mounting bracket.

4. The seatbelt device of claim 3, wherein due to the rotational movement of the buckle fixedly attached to the buckle cable, the buckle in the actuated position is located forward and downward from the buckle located in the unactuated position.

5. The seatbelt device of claim 1, wherein the load transmission system is attached to the buckle mounting bracket and further includes a gas generator configured to move the driving member inside the housing along a longitudinal axis of the housing at the time of the vehicle collision or at the time the vehicle collision is anticipated.

6. The seatbelt device of claim 5, wherein when the load transmission system is actuated, the driving member connected with the pre-tensioner cable moves forward along the longitudinal axis of the housing such that the driving member retracts the pre-tensioner cable inside the housing.

7. The seatbelt device of claim 5, wherein when the load transmission system is actuated, the driving member connected with the pre-tensioner cable moves rearward along the longitudinal axis of the housing such that the driving member retracts the pre-tensioner cable inside the housing.

8. The seatbelt device of claim 1, due to the movement of the buckle engaged with a lap belt portion of the webbing via the tongue plate, the seatbelt device is configured to reduce submarining load on the occupant at the time of the vehicle collision or at the time the vehicle collision is anticipated.

9. A seatbelt device with a tongue plate of a webbing restraining an occupant seated in a vehicle seat, the seatbelt device comprising:
a buckle assembly including a buckle releasably receiving the tongue plate and a buckle cable having a first buckle cable end rotatably attached to a buckle mounting bracket of the vehicle seat and a second buckle cable end fixedly connected to the buckle; and
a pre-tensioner system including a housing, a driving member movable along a longitudinal axis of the housing, and a pre-tensioner cable having a first end fixedly connected to the driving member and a second end fixedly connected to the second buckle cable end of the buckle cable at a location next to the buckle,
wherein the driving member retracts the pre-tensioner cable inside the housing when the pre-tensioner system is actuated at a time of a vehicle collision or at a time the vehicle collision is anticipated such that the buckle assembly is rotatably moved and configured to reduce submarining load on the occupant.

10. The seatbelt device of claim 9, further comprising a coupling member providing a connection between the second end of the pre-tensioner cable and the second buckle cable end of the buckle cable such that the pre-tensioner cable and the buckle cable are fixedly connected to each other.

11. The seatbelt device of claim 9, wherein due to the rotational movement of the buckle assembly, the buckle in an actuated position is located forward and downward from the buckle located in an unactuated position.

12. The seatbelt device of claim 9, wherein the pre-tensioner system is attached to the buckle mounting bracket and further includes a gas generator configured to move the driving member disposed inside the housing along the longitudinal axis of the housing at the time of the vehicle collision or at the time the vehicle collision is anticipated.

13. The seatbelt device of claim 12, wherein when the pre-tensioner system is actuated, the driving member connected to the pre-tensioner cable inside the housing moves forward along the longitudinal axis of the housing.

14. A seatbelt device for securing an occupant seated in a vehicle seat, the seatbelt device comprising:
a seatbelt webbing slidably connected with a tongue plate for restraining the occupant, the seatbelt webbing having an end rotatably connected to a mounting bracket of the vehicle seat;
a load transmission system including a housing and a driving member disposed inside the housing; and
a pre-tensioner cable having a first end fixedly connected to the driving member and a second end connected with a portion of the seatbelt webbing,
wherein the portion of the seatbelt webbing connected to the second end of the pre-tensioner cable is rotatably moved to an actuated position from an unactuated position when the load transmission system is actuated at a time of a vehicle collision or at a time the vehicle collision is anticipated.

15. The seatbelt device of claim 14, further comprising a coupling member providing a connection between the second end of the pre-tensioner cable and the portion of the seatbelt webbing such that the pre-tensioner cable and the seatbelt webbing are connected to each other.

16. The seatbelt device of claim 15, wherein, in the actuated position of the seatbelt webbing, the coupling member attached to the seatbelt webbing rotates forward about an anchor defined as a location where an end of an lap belt portion is rotatably attached to the mounting bracket.

17. The seatbelt device of claim 15, wherein due to the rotational movement of the coupling member attached to the seatbelt webbing, the coupling member in the actuated position is located forward and downward from the coupling member located in the unactuated position.

18. The seatbelt device of claim 14, wherein the load transmission system is attached to the mounting bracket and further includes a gas generator configured to move the driving member inside the housing along a longitudinal axis of the housing at the time of the vehicle collision or at the time the vehicle collision is anticipated.

19. The seatbelt device of claim 18, wherein when the load transmission system is actuated, the driving member connected with the pre-tensioner cable moves forward along the longitudinal axis of the housing such that the driving member retracts the pre-tensioner cable inside the housing.

20. The seatbelt device of claim 15, due to the movement of the coupling member engaged with a lap belt portion of the seatbelt webbing, the seatbelt device is configured to reduce submarining load on the occupant at the time of the vehicle collision or at the time the vehicle collision is anticipated.
